(19) United States
(12) Patent Application Publication
(10) Pub. No.: US 2022/0033030 A1
(43) Pub. Date: Feb. 3, 2022

(54) HANDLEBAR ASSEMBLY

(71) Applicant: Shimano Inc., Osaka (JP)

(72) Inventors: Hiroshi MATSUMOTO, Osaka (JP); Ayako TAKAHASHI, Osaka (JP); Kodai HIROTA, Osaka (JP); Takuma SAKAI, Osaka (JP); Takafumi NISHINO, Osaka (JP)

(21) Appl. No.: 16/983,237

(22) Filed: Aug. 3, 2020

(51) Int. Cl. B62K 23/02; B62K 21/12; H01H 21/24; H01H 21/04

(52) U.S. Cl. CPC B62K 23/02; H01H 21/04; H01H 21/24; B62K 21/12

(57) ABSTRACT

A handlebar assembly is basically provided with a handlebar and a support. The handlebar has an outer circumferential surface and an arrangement area disposed inside the outer circumferential surface. The arrangement area is configured to arrange an electric switch unit at least partially inside the outer circumferential surface. The support is at least partially disposed in the arrangement area and supporting the electric switch unit to receive an operating force applied to operate the electric switch unit.

### BACKGROUND

### Technical Field

This disclosure generally relates to a handlebar assembly. More specifically, the present disclosure relates to a handlebar assembly that is used with a human steered vehicle.

### Background Information

Human steered vehicles such as bicycles, motorcycles, all-terrain vehicles (ATVs), personal watercrafts and snowmobiles are typically provided with a handlebar for a rider to steer the vehicle. Often, these vehicles are provided with various user operated components that are mounted on the handlebar. The user operated components are usually mounted on the handlebar by a clamp that has a band portion encircling around an exterior surface of the handlebar. For example, U.S. Patent Application Publication No. 2019/0308687 (assigned to Shimano Inc.) discloses a user operated component (i.e., an operating device having an electric switch) that is mounted around an exterior surface of a handlebar.

### SUMMARY

Generally, the present disclosure is directed to various features of a handlebar assembly for arranging an electric switch on a handlebar. It has been discovered that there can be disadvantages to mounting an electric switch to an exterior surface of a handlebar using a conventional band type clamp. For example, when using a conventional band type clamp, the electric switch unit is spaced away from the exterior surface of the handlebar, which makes a visually appearance of the handlebar inelegant. At least some of these disadvantages of a conventional band type clamp can be overcome by using a handlebar assembly of the present disclosure.

In view of the state of the known technology and in accordance with a first aspect of the present disclosure, a handlebar assembly is provided that basically comprises a handlebar and a support. The handlebar has an outer circumferential surface and an arrangement area disposed inside the outer circumferential surface. The arrangement area is configured to arrange an electric switch unit at least partially inside the outer circumferential surface. The support is at least partially disposed in the arrangement area and supporting the electric switch unit to receive an operating force applied to operate the electric switch unit.

With the handlebar assembly according to the first aspect, it is possible to provide an electric switch unit that does not protrude as far as a conventional electric switch unit from a handlebar. It is, thus, possible to provide a visually pleasing appearance to the handlebar assembly.

In accordance with a second aspect of the present disclosure, the handlebar assembly according to the first aspect further comprises a cover arranged to at least partially overlying the electric switch unit.

With the handlebar assembly according to the second aspect, it is possible to easily install the electric switch unit in the arrangement area of the handlebar and to at least partly hide the electric switch unit. It is, thus, possible to provide a visually more pleasing appearance to the handlebar assembly.

In accordance with a third aspect of the present disclosure, the handlebar assembly according to the second aspect is configured so that the cover is arranged such that the electric switch unit is clamped between the cover and the support.

With the handlebar assembly according to the third aspect, it is possible to simply secure the electric switch unit to the handlebar with a relatively small number of parts.

In accordance with a fourth aspect of the present disclosure, the handlebar assembly according to the third aspect is configured so that the cover includes an elastic part to receive the operating force.

With the handlebar assembly according to the fourth aspect, it is possible to protect the electric switch unit from water and other foreign substances.

In accordance with a fifth aspect of the present disclosure, the handlebar assembly according to any one of the second to fourth aspects is configured so that the cover is removably coupled to at least one of the handlebar and the support.

With the handlebar assembly according to the fifth aspect, it is possible to easily install and remove the electric switch unit from the arrangement area of the handlebar.

In accordance with a sixth aspect of the present disclosure, the handlebar assembly according to any one of the second to fifth aspects is configured so that the cover includes a cover opening to at least partly expose the electric switch.

With the handlebar assembly according to the sixth aspect, it is possible to easily operate the electric switch.

In accordance with a seventh aspect of the present disclosure, the handlebar assembly according to any one of the second to sixth aspects is configured so that the cover includes an elastic part to receive the operating force.

With the handlebar assembly according to the seventh aspect, it is possible to protect the electric switch unit from water and other foreign substances.

In accordance with an eighth aspect of the present disclosure, the handlebar assembly according to any one of the second to seventh aspects is configured so that the cover is configured to be flush with the outer circumferential surface of the handlebar at least around an outer edge portion of the cover.

With the handlebar assembly according to the eighth aspect, it is possible to provide a visually more pleasing appearance to the handlebar assembly.

In accordance with a ninth aspect of the present disclosure, the handlebar assembly according to any one of the first to eighth aspects is configured so that the support is adhesively attached to the handlebar.

With the handlebar assembly according to the ninth aspect, it is possible to securely attach the support to the handlebar.

In accordance with a tenth aspect of the present disclosure, the handlebar assembly according to any one of the first to eighth aspects is configured so that the support is removably coupled to the handlebar.

With the handlebar assembly according to the tenth aspect, it is possible to easily remove the electric switch unit from in the arrangement area of the handlebar.

In accordance with an eleventh aspect of the present disclosure, the handlebar assembly according to any one of the first to tenth aspects is configured so that the arrangement area includes an interior space in which the electric switch unit is arranged.

With the handlebar assembly according to the eleventh aspect, it is possible to arrange the electric switch unit is a protected space.

In accordance with a twelfth aspect of the present disclosure, the handlebar assembly according to the eleventh aspect is configured so that the handlebar has a handlebar opening to access the interior space, and the support is snap-fitted into the handlebar opening.

With the handlebar assembly according to the twelfth aspect, it is possible to easily install the electric switch unit in the arrangement area of the handlebar.

In accordance with a thirteenth aspect of the present disclosure, the handlebar assembly according to any one of the first to twelfth aspects is configured so that the support includes a handlebar attachment disposed in the arrangement area, the handlebar attachment is made of an elastomeric material.

With the handlebar assembly according to the thirteenth aspect, it is possible to install the electric switch unit in the arrangement area of the handlebar.

In accordance with a fourteenth aspect of the present disclosure, the handlebar assembly according to any one of the first to thirteenth aspects is configured so that the arrangement area includes a recess, and the electric switch unit is at least partially disposed in the recess.

With the handlebar assembly according to the fourteenth aspect, it is possible to arrange the electric switch unit in a protected recess.

In accordance with a fifteenth aspect of the present disclosure, the handlebar assembly according to any one of the first to fourteenth aspects is configured so that the support is threadedly attached to the handlebar.

With the handlebar assembly according to the fifteenth aspect, it is possible to attach and detach the electric switch unit to the handlebar.

In accordance with a sixteenth aspect of the present disclosure, the handlebar assembly according to any one of the first to fourteenth aspects is configured so that the support is bolted to the handlebar.

With the handlebar assembly according to the sixteenth aspect, it is possible to attach and detach the electric switch unit to the handlebar.

In accordance with a seventeenth aspect of the present disclosure, the handlebar assembly according to any one of the first to sixteenth aspects is configured so that the support is clamped between the electric switch unit and the handlebar.

With the handlebar assembly according to the seventeenth aspect, it is possible to simply secure the electric switch unit to the handlebar with a relatively small number of parts.

In accordance with an eighteenth aspect of the present disclosure, the handlebar assembly according to any one of the first to seventeenth aspects further comprises the electric switch unit.

With the handlebar assembly according to the eighteenth aspect, it is possible to provide a complete handlebar assembly.

In accordance with a nineteenth aspect of the present disclosure, the handlebar assembly according to the eighteenth aspect is configured so that the electric switch unit includes a housing and an operating portion pivotally coupled to the housing.

With the handlebar assembly according to the nineteenth aspect, it is possible to easily operate an electric switch unit.

In accordance with a twentieth aspect of the present disclosure, the handlebar assembly according to the nineteenth aspect is configured so that the operating portion at least partially extends beyond the outer circumferential surface in a radial direction of the handlebar.

With the handlebar assembly according to the twentieth aspect, it is possible to easily operate an electric switch unit.

Also, other objects, features, aspects and advantages of the disclosed handlebar assembly will become apparent to those skilled in the art from the following detailed description, which, taken in conjunction with the annexed drawings, discloses preferred embodiments of the handlebar assembly.

### BRIEF DESCRIPTION OF THE DRAWINGS

Referring now to the attached drawings which form a part of this original disclosure:

FIG. 1 is a perspective view of a front portion of a human steered vehicle (i.e., a bicycle) having a handlebar assembly that includes a handlebar and at least one support at least partially disposed in an arrangement area of the handlebar for supporting an electric switch unit in accordance with a first embodiment;

FIG. 2 is a partial cross sectional view of the handlebar assembly as viewed along section line 2-2 in FIG. 1;

FIG. 3 is a perspective view of one of the electric switch units of the handlebar assembly illustrated in FIG. 1;

FIG. 4 is an exploded perspective view of the electric switch unit illustrated in FIGS. 2 and 3;

FIG. 5 is a cross sectional view of the electric switch unit as viewed along section line 5-5 in FIG. 3;

FIG. 6 is a perspective view of another one of the electric switch units of the handlebar assembly illustrated in FIG. 1;

FIG. 7 is a partial exploded perspective view of the switch unit illustrated in FIGS. 1 and 6;

FIG. 8 is a perspective view of another one of the electric switch units of the handlebar assembly illustrated in FIG. 1;

FIG. 9 is a partial exploded perspective view of the switch unit illustrated in FIGS. 1 and 8;

FIG. 10 is a partial cross sectional view, similar to FIG. 2, of a handlebar assembly taken along a longitudinal section line of a handlebar in accordance with a second embodiment;

FIG. 11 is a partial cross sectional view, similar to FIG. 2, of a handlebar assembly taken along a longitudinal section line of a handlebar in accordance with a third embodiment;

FIG. 12 is a partial cross sectional view, similar to FIG. 2, of a handlebar assembly taken along a longitudinal section line of a handlebar in accordance with a fourth embodiment;

FIG. 13 is a partial cross sectional view, similar to FIG. 2, of a handlebar assembly taken along a longitudinal section line of a handlebar in accordance with a fifth embodiment;

FIG. 14 is a partial cross sectional view, similar to FIG. 2, of a handlebar assembly taken along a longitudinal section line of a handlebar in accordance with a sixth embodiment;

FIG. 15 is a transverse cross sectional view of the handlebar assembly illustrated in FIG. 14;

FIG. 16 is a partial cross sectional view, similar to FIG. 2, of a handlebar assembly in accordance with a seventh embodiment;

FIG. 17 is a transverse cross sectional similar to FIG. 15, of a handlebar assembly in accordance with an eighth embodiment;

FIG. 18 is an exploded perspective view of a handlebar assembly in accordance with a ninth embodiment;

FIG. 19 is a transverse cross sectional similar to FIG. 15, of the handlebar assembly in accordance illustrated in FIG. 18; and

FIG. 20 is a perspective view of a handlebar assembly in which an electric switch unit is provided on a rearwardly facing side of a center section of a handlebar in accordance with a tenth embodiment.

### DETAILED DESCRIPTION OF EMBODIMENTS

Selected embodiments will now be explained with reference to the drawings. It will be apparent to those skilled in the human steered vehicle field (e.g., the bicycle, motorcycle, all-terrain vehicle (ATVs), personal watercraft and snowmobile fields) from this disclosure that the following descriptions of the embodiments are provided for illustration only and not for the purpose of limiting the invention as defined by the appended claims and their equivalents.

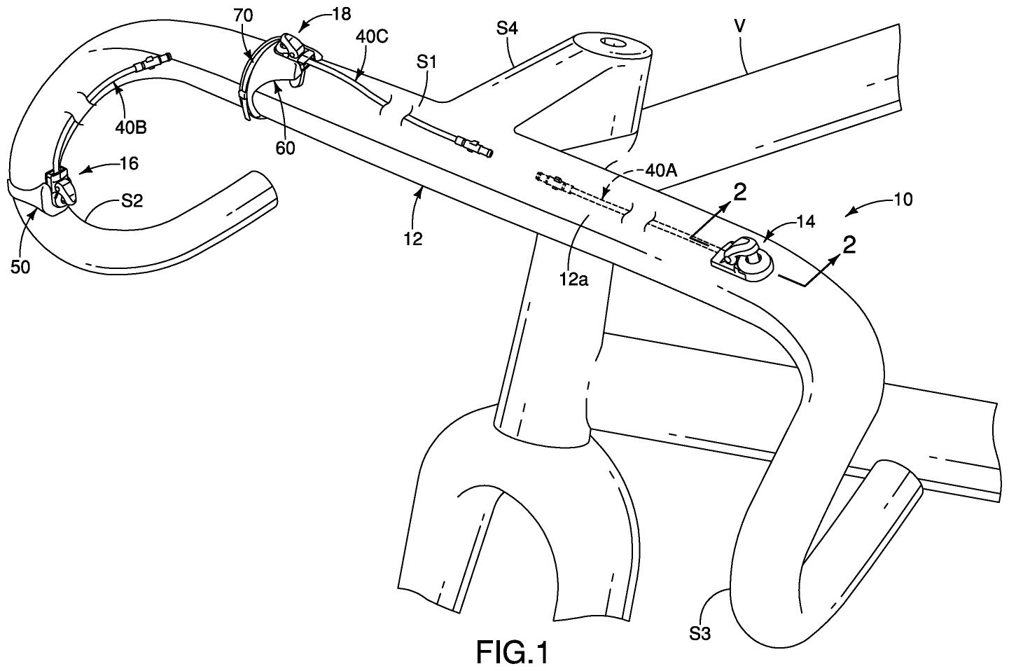

Referring initially to FIG. 1, a handlebar assembly 10 is illustrated that is used with a human steered vehicle V. Here, the human steered vehicle V is a bicycle (only a front portion is shown in FIG. 1). Thus, in the illustrated embodiments, the handlebar assembly 10 is a bicycle handlebar assembly. Basically, the handlebar assembly 10 comprises a handlebar 12. In the illustrated embodiments, the handlebar 12 is a drop handlebar that includes a center section S1, a first curved section S2 extending from a first end of the center section S1, and a second curved section S3 from a second end of extending from the center section S1. The center section S1 is generally a straight section that is coupled to a steering device (e.g., a front fork) of the human steered vehicle V. Here, the handlebar 12 includes an integrated handlebar stem S4 that is integrally formed with a middle area of the center section S1 in a non-removable manner. Alternatively, a removable handlebar stem can be attached to the center section S1 of the handlebar 12. Also, it will be apparent from this disclosure that the handlebar 12 is not limited to a drop handlebar, but rather change have other configurations as needed and/or desired.

As seen in FIG. 1, the handlebar assembly 10 further comprises an electric switch unit 14. Here, the electric switch unit 14 is mounted to the center section S1 of the handlebar 12. However, the location of the electric switch unit 14 is not limited to the center section S1 of the handlebar 12. Also, for example, the electric switch unit 14 can be provided on a rearward facing surface of the center section S1 of the handlebar 12. The electric switch unit 14 is electrically connected to an electrical component that is provided on the human steered vehicle V. Here, the the handlebar assembly 10 further comprises an additional electric switch unit 16 that is mounted on the right side of the center section S1 of the handlebar 12 as viewed while seated on the human steered vehicle V. Also, the the handlebar assembly 10 further comprises an additional electric switch unit 18 that is mounted on the first curved section S2 of the handlebar 12. The additional electric switch units 16 and 18 are each electrically connected to an electrical component that is provided on the human steered vehicle V. The electric switch units 14, 16 and 18 are all identical, but are mounted to the handlebar 12 using different mounting structures to form a low profile handlebar assembly. The handlebar 12 has an outer circumferential surface 12a. As explained below, the electric switch units 16 and 18 are mounted to the handlebar 12 such that the electric switch units 16 and 18 each directly contact the outer circumferential surface 12a of the handlebar 12. On the other hand, the electric switch unit 14 is at least partial disposed inside the handlebar 12 as explained below.

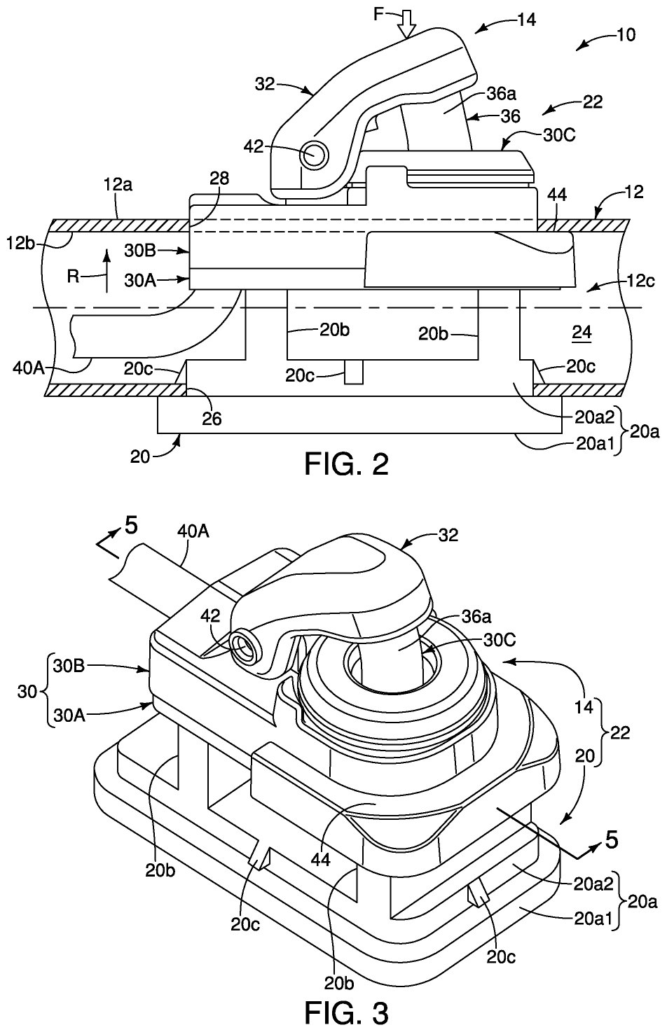

Referring now to FIGS. 2 and 3, the handlebar assembly 10 comprises a support 20. The support 20 and the electric switch unit 14 form a first electric switch assembly 22. The support 20 holds the electric switch unit 14 in place such that the electric switch unit 14 is at least partial disposed inside the handlebar 12. Also, as seen in FIG. 2, the support 20 supports the electric switch unit 14 to receive an operating force F that is applied to operate the electric switch unit 14. The handlebar assembly 10 can comprises the handlebar 12 and the support 20, while the electric switch unit 14 can be a separate part that is adapted to be provided to the handlebar assembly 10.

The handlebar 12 has an arrangement area 24 that is disposed inside the outer circumferential surface 12a. The arrangement area 24 is configured to arrange the electric switch unit 14 at least partially inside the outer circumferential surface 12a. Here, in the first embodiment, the arrangement area 24 is defined by an internal surface 12b of the handlebar 12. Thus, the arrangement area 24 includes an interior space 12c in which the electric switch unit 14 is arranged. The support 20 is at least partially disposed in the arrangement area 24.

More specifically, as seen in FIG. 2, the handlebar 12 has a handlebar opening 26 to access the interior space 12c, and the support 20 is snap-fitted into the handlebar opening 26. The handlebar 12 also has a handlebar opening or locating opening 28 in which the electric switch unit 14 is located. The electric switch unit 14 is held against the internal surface 12b by the support 20, which is snap-fitted into the handlebar opening 26, such that the electric switch unit 14 partially projects out from the handlebar 12 through the handlebar opening 28.

Here, the support 20 includes a base 20a, a pair of columns 20b and a plurality of detents or prongs 20c. The base 20a has a first part 20a1 and a second part 20a2 that forms a step configuration. The first part 20a1 is dimensioned to completely cover the handlebar opening 26 and contact the outer circumferential surface 12a of the handlebar 12. The second part 20a2 is dimensioned to snugly fit in the handlebar opening 26. The columns 20b extend from the second part 20a2, and are dimensioned to contact the electric switch unit 14. In this way, the columns 20b of the support 20 presses against the electric switch unit 14 to hold the electric switch unit 14 against the internal surface 12b of the handlebar 12. The detents 20c are provided to the second part 20a2 and configured to engage the the internal surface 12b of the handlebar 12. In this way, the support 20 is retained in the handlebar opening 26 and pressed against the electric switch unit 14. Thus, the support 20 includes a handlebar attachment (the detents 20c) that is disposed in the arrangement area 24. The handlebar attachment (the detents 20c) is made of an elastomeric material. Here, the support 20 is a one-piece member that is entirely made of an elastomeric material such as rubber or soft resin. However, it will be apparent from this disclosure that the support 20 is not limited to being a one-piece member and/or being made of an elastomeric material.

By using a snap-fit arrangement, the support 20 is removably coupled to the handlebar 12. By using a resilient material (e.g., an elastomeric material) for at least the detents 20c of the support 20, the support 20 can be installed in the handlebar opening 26, removed from handlebar opening 26 with substantially no significant damage such that the support 20 can be reinstalled without be repaired. However, the support 20 is not limited to be removably coupled to the handlebar 12 by the illustrated snap-fit arrangement. It will be apparent from this disclosure that the support 20 can be removably coupled to the handlebar 12 in other ways, including, but not limited to, screws, bolts, clips, clasps, etc.

Referring now to FIGS. 2 to 5, the electric switch unit 14 will now be discussed in more detail. Here, the electric switch unit 14 is a push operated electric switch unit. The electric switch unit 14 includes a housing 30 and an operating portion 32 that is pivotally coupled to the housing 30. The electric switch unit 14 further includes an electric switch 34 that is disposed in the housing 30. The electric switch 34 is a push button switch having a depressible button 34a that is operated (depressed) in response to movement of the operating portion 32 with respect to the housing 30 from a rest position to an operated position. The operating portion 32 at least partially extends beyond the outer circumferential surface 12a in a radial direction R of the handlebar 12.

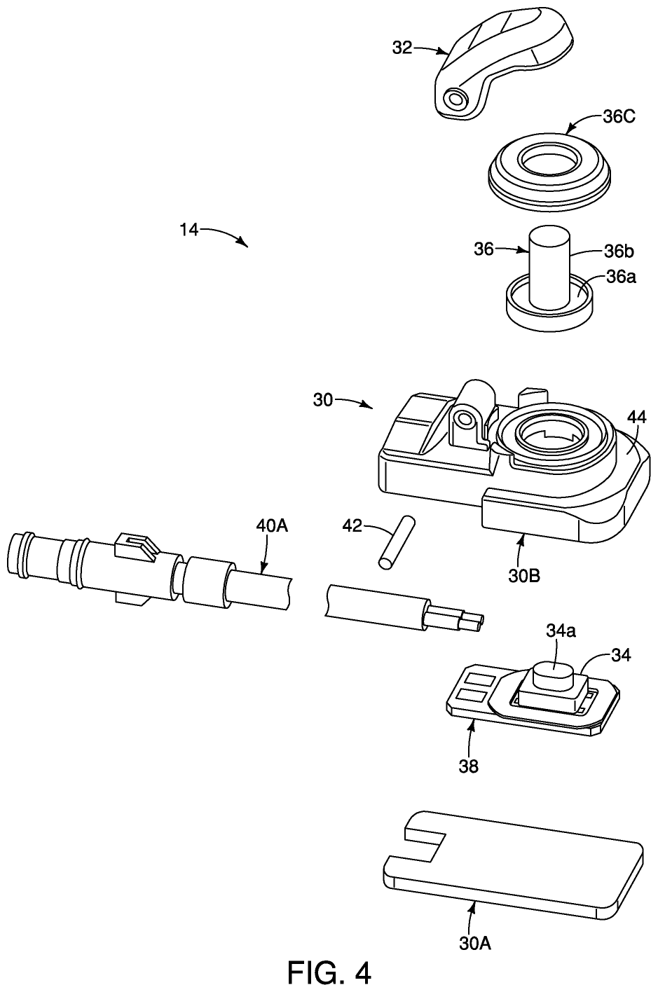

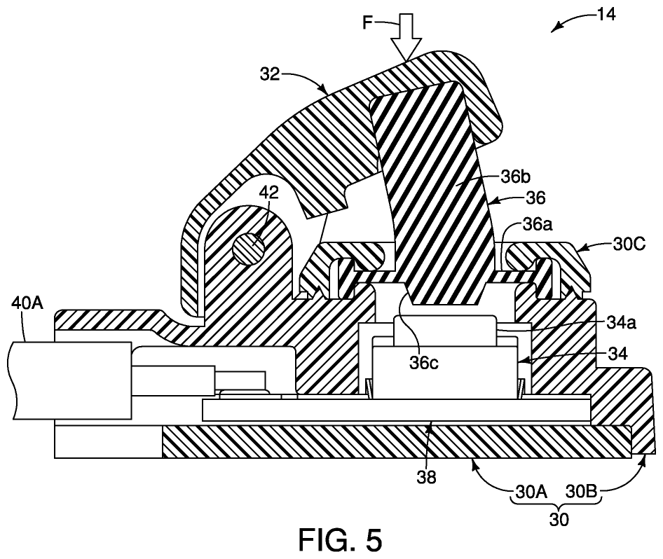

Referring to FIGS. 4 and 5, the electric switch unit 14 further includes an actuator 36 that is disposed between the housing 30 and the operating portion 32. Here, the actuator 36 acts as a biasing element that maintains the operating portion 32 in the rest position, which also corresponds to a non-activation position. Thus, if an external force is not applied to operating portion 32, the actuator 36 biases the operating portion 32 to the rest position in which the electric switch 34 is not activated. As seen in FIG. 5, the actuator 36 is preferably a one-piece member that is entirely made of an elastomeric material such as rubber. The actuator 36 includes a resilient hinge portion 36a, an input receiving portion 36b and an actuation portion 36c. The resilient hinge or flange portion 36a is coupled to the housing 30. The input receiving portion 36b extends from the resilient hinge portion 36a and contacts the operating portion 32. The actuation portion 36c extends from the resilient hinge portion 36a in the opposite direction from the input receiving portion 36b. If the operating portion 32 is in the rest position (non-activation position), the actuation portion 36c is spaced from the electric switch 34 and the electric switch 34 is not activated. If the operating portion 32 is depressed by a user, the resilient hinge portion 36a temporarily deforms due to a user operating force that is transmitted from the operating portion 32 to the input receiving portion 36b. This temporarily deformation of the resilient hinge portion 36a results in the actuation portion 36c contacting and depressing the electric switch 34 to active the switch. Once the user releases the user operating force from the operating portion 32, the resilient hinge portion 36a returns to its pre-deformed state in which the operating portion 32 is in the rest position.

Here, the electric switch unit 14 further includes a printed circuit board 38. The electric switch 34 is mounted on the printed circuit board 38, which is electrically connected to an electrical cord 40A. The electric switch 34 and the printed circuit board 34 are disposed inside the housing 30. Here, the housing 30 includes a base part 30A, a cover part 30B and a ring part 30C. Each of the base part 30A, the cover part 30B and the ring part 30C can be made of a suitable material such as a hard resin material. The cover part 30B is fixed to the base part 30A to cover and protect the electric switch 34. The ring part 30C is fixed to the cover part 30B to secure the actuator 36 to the housing 30. Specifically, an outer peripheral edge of the resilient hinge portion 36a is sandwiched between the ring part 30C and the cover part 30B. A pivot pin 42 pivotally attaches the operating portion 32 to the cover part 30B of the housing 30.

As seen in FIG. 2, the cover part 30B is configured to mate with the handlebar opening 28 of the handlebar 12. In this way, the operating portion 32 at least partially projects from the handlebar opening 28 of the handlebar 12. Here, the cover part 30B has an abutment surface 44 that abuts the internal surface 12b of the handlebar 12 in a state where the electric switch unit 14 is supported by the support 20.

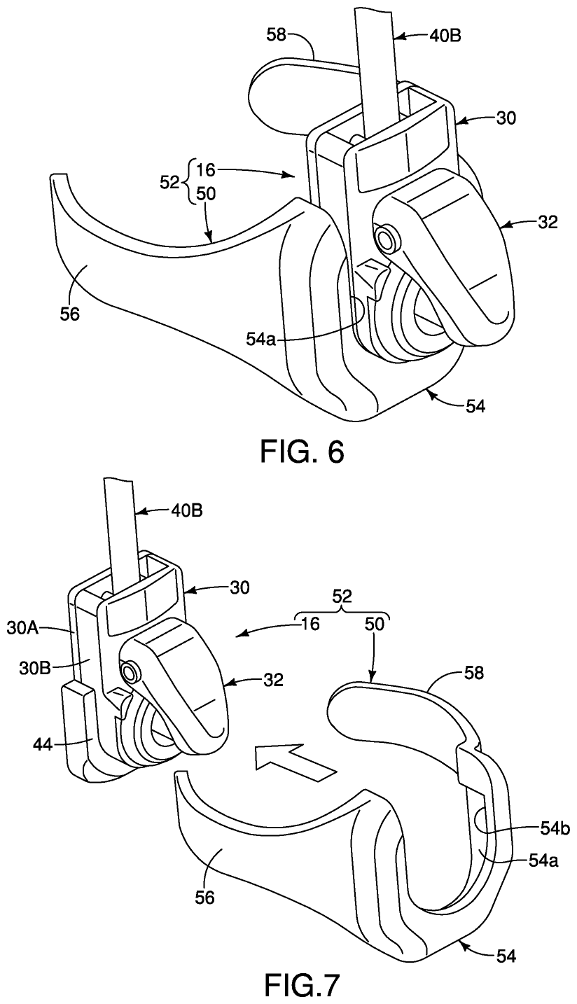

Referring now to FIGS. 1, 6 and 7, the electric switch unit 16 will now be discussed in further detail. The electric switch unit 16 is electrically connected to an electrical component of the vehicle V by an electrical cord 40B. Here, as seen in FIG. 1, the electric switch unit 16 is coupled to the outer circumferential surface 12a of the handlebar 12 by a support 50. The support 50 and the electric switch unit 16 form a second electric switch assembly 52. The electric switch unit 16 is identical to the electric switch unit 14. Thus, the parts of the electric switch unit 16 will be give the same reference numerals as the electric switch unit 14. Namely, the electric switch unit 16 basically includes the housing 30 and the operating portion 32 that is pivotally coupled to the housing 30. The base part 30A of the housing 30 is configured to directly contact the outer circumferential surface 12a of the handlebar 12 and the cover part 30B of the housing 30 is in contact with the support 50.

The support 50 is a spring clip that holds the electric switch unit 16 in direct contact with the outer circumferential surface 12a of the handlebar 12. The support 50 is preferably made of a resilient material that firmly holds the support 50 on the handlebar 12. For example, the support 50 can be constricted of a relatively hard resin material with sufficient resiliency to be snapped onto the first curved section S2 on the handlebar 12 and snapped off the first curved section S2 on the handlebar 12 as needed and/or desired. While the support 50 in the illustrated embodiment is specifically designed for the first curved section S2 on the handlebar 12, it will be apparent from this disclosure that the support 50 can be configured to mate with other sections of the handlebar 12 as needed and/or desired.

The support 50 has a switch support body 54, a first attachment arm 56 and a second attachment arm 58. Here, the support 50 is a one-piece member made of a suitable resin material. The switch support body 54 has a switch receiving opening 54a for receiving the cover part 30B of the housing 30 of the electric switch unit 16. Preferably, the electric switch unit 18 is snuggly received in the switch receiving opening 54a. The switch support body 54 has a restraining surface 54b that is adjacent the switch receiving opening 54a. Here, the restraining surface 54b is in the form of a recess that receives the abutment surface 44 on the cover part 30B of the housing 30. In this way, the restraining surface 54b is configured to contact the abutment surface 44 on the cover part 30B of the housing 30 for restraining the electric switch unit 16 from moving in a state where the support 50 is attached to the handlebar 12 with the electric switch unit 16 disposed therebetween.

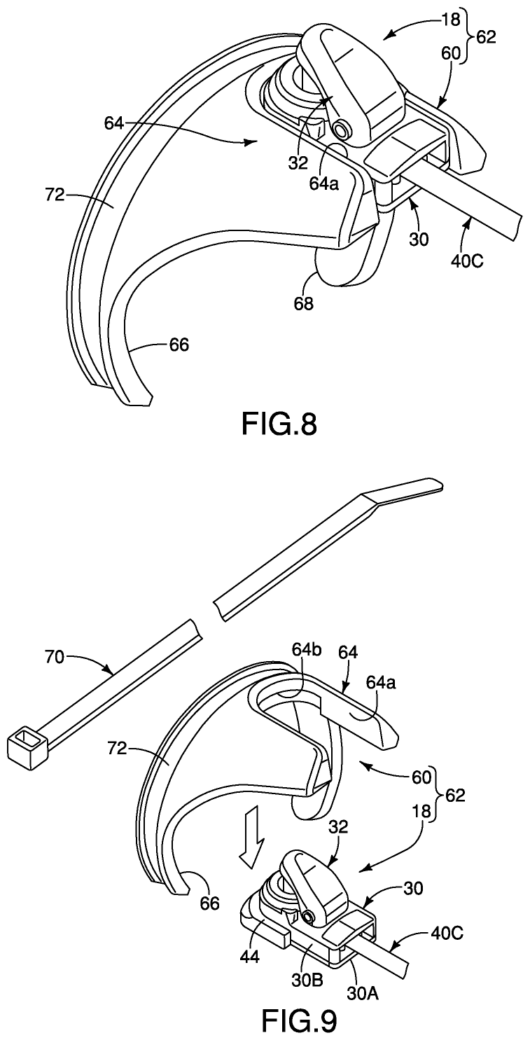

Referring now to FIGS. 1, 8 and 9, the electric switch unit 18 will now be discussed in further detail. The electric switch unit 18 is electrically connected to an electrical component of the vehicle V by an electrical cord 40C. Here, as seen in FIG. 1, the electric switch unit 18 is coupled to the outer circumferential surface 12a of the handlebar 12 by a support 60. The support 60 and the electric switch unit 18 form a third electric switch assembly 62. The electric switch unit 18 is identical to the electric switch units 14 and 16. Thus, the parts of the electric switch unit 18 will be give the same reference numerals as the electric switch units 14 and 16. Namely, the electric switch unit 18 basically includes the housing 30 and the operating portion 32 that is pivotally coupled to the housing 30. The base part 30A of the housing 30 is configured to directly contact the outer circumferential surface 12a of the handlebar 12 and the cover part 30B of the housing 30 is in contact with the support 60.

The support 60 holds the electric switch unit 18 in direct contact with the outer circumferential surface 12a of the handlebar 12. While the support 60 in the illustrated embodiment is attached to the center section S1 on the handlebar 12, it will be apparent from this disclosure that the support 60 can be configured to mate with other sections of the handlebar 12 as needed and/or desired. The support 60 has a switch support body 64, a first attachment arm 66 and a second attachment arm 68. Here, the support 60 is a one-piece member made of a suitable flexible material such as an elastomeric material or a flexible resin material. A plastic tie strap 70 is used to secure the support 60 and the electric switch unit 18 to the handlebar 12. Here, the support 60 has a groove or recess 72 for receiving the plastic tie strap 70. The groove 72 extends along the switch support body 64, the first attachment arm 66 and the second attachment arm 68.

The switch support body 64 has a switch receiving opening 64a for receiving the cover part 30B of the housing 30 of the electric switch unit 18. Preferably, the electric switch unit 18 is snuggly received in the switch receiving opening 64a. The switch support body 64 has a restraining surface 64b that is adjacent the switch receiving opening 64a. Here, the restraining surface 64b is in the form of a recess that receives the abutment surface 44 on the cover part 30B of the housing 30. In this way, the restraining surface 64b is configured to contact the abutment surface 44 on the cover part 30B of the housing 30 for restraining the electric switch unit 18 from moving in a state where the support 60 is attached to the handlebar 12 with the electric switch unit 18 disposed therebetween.

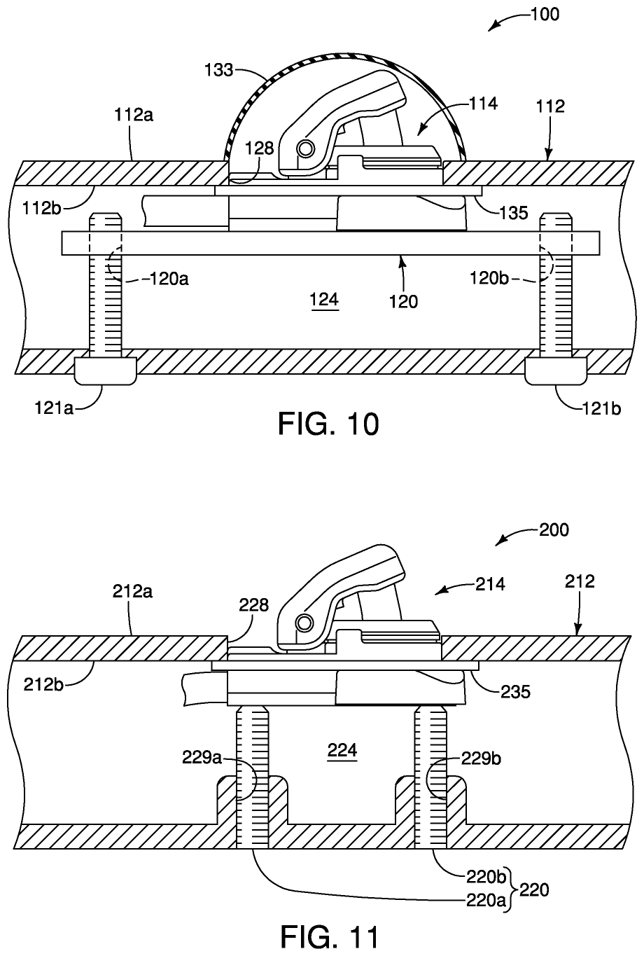

Referring now to FIG. 10, a handlebar assembly 100 is illustrated in accordance with a second embodiment. Here, the handlebar assembly 100 includes a handlebar 112, an electric switch unit 114 and a support 120. The handlebar 112 can be any type of handlebar. In any case, similar to the handlebar 12, the handlebar 112 has an outer circumferential surface 112a and the arrangement area 124 that is disposed inside the outer circumferential surface 112a. The arrangement area 124 is configured to arrange the electric switch unit 114 at least partially inside the outer circumferential surface 112a of the handlebar 112. Here, in the second embodiment, the arrangement area 124 is defined by an internal surface 112b of the handlebar 112.

The electric switch unit 114 is identical to the electric switch unit 14. Thus, the above descriptions and the illustrations of the electric switch unit 14 applies to the electric switch unit 114. The handlebar 112 also has a handlebar opening or locating opening 128 in which the electric switch unit 114 is at least partially located. The electric switch unit 114 is held against the handlebar 112 by the support 120 such that the electric switch unit 114 partially projects out from the handlebar 112 through the handlebar opening 128. Here, the support 120 is a rigid member such as a hard resin plate. The support 120 is bolted to the handlebar 112. In particular, the support 120 is bolted to the handlebar 112 by a pair of bolts 121a and 121b. The bolts 121a and 121b are screwed into threaded holes 120a and 120b, respectively, that are provided in the support 120. In this way, the support 120 is pressed against the electric switch unit 114, which in turn is pressed against the internal surface 112b of the handlebar 112.

Optionally, the handlebar assembly 100 can be provided with an elastic part 133 to receive an operating force of a user for operating the electric switch unit 114. The elastic part 133 can be a clear dome shaped cover that is resilient such that it returns to its original shape after being deformed by a user operating the electric switch unit 114. Preferably, the elastic part 133 is coupled to the outer circumferential surface 112a to provide a waterproof seal around the electric switch unit 114.

Optionally, a rubber coated washer or gasket 135 can be provided between the internal surface 112b of the handlebar 112 and the electric switch unit 114 to provide additional waterproofing and/or aid in stabilizing the electric switch unit 114 against the electric switch unit 114.

Referring now to FIG. 11, a handlebar assembly 200 is illustrated in accordance with a third embodiment. Here, the handlebar assembly 200 includes a handlebar 212, an electric switch unit 214 and a support 220. The handlebar 212 can be any type of handlebar. In any case, similar to the handlebar 12, the handlebar 212 has an outer circumferential surface 212a and the arrangement area 224 that is disposed inside the outer circumferential surface 212a. The arrangement area 224 is configured to arrange the electric switch unit 214 at least partially inside the outer circumferential surface 212a of the handlebar 212. Here, in the third embodiment, the arrangement area 224 is defined by an internal surface 212b of the handlebar 212.

The electric switch unit 214 is identical to the electric switch unit 14. Thus, the above descriptions and the illustrations of the electric switch unit 14 applies to the electric switch unit 214. The handlebar 212 also has a handlebar opening or locating opening 228 in which the electric switch unit 214 is at least partially located. The electric switch unit 214 is held against the handlebar 212 by the support 220 such that the electric switch unit 214 partially projects out from the handlebar 212 through the handlebar opening 228. Here, the support 220 includes a pair of set screws 220a and 220b that are threaded into holes 229a and 229b of the handlebar 212. In this way, the support 220 is threadedly attached to the handlebar 212.

Optionally, a rubber coated washer or gasket 235 can be provided between the internal surface 212b of the handlebar 212 and the electric switch unit 214 to provide additional waterproofing and/or aid in stabilizing the electric switch unit 214 against the electric switch unit 214.

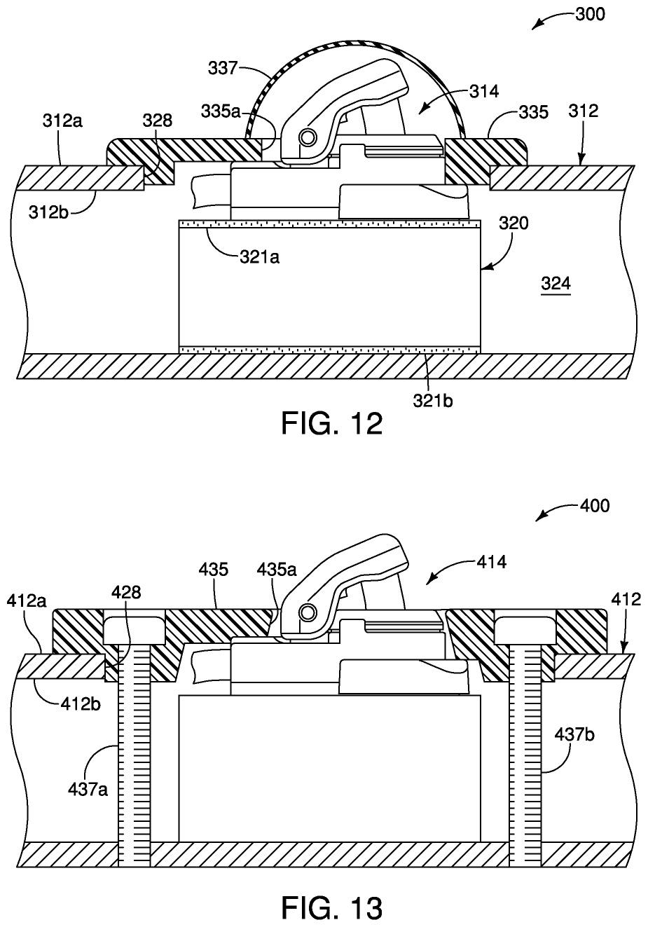

Referring now to FIG. 12, a handlebar assembly 300 is illustrated in accordance with a fourth embodiment. Here, the handlebar assembly 300 includes a handlebar 312, an electric switch unit 314 and a support 320. The handlebar 312 can be any type of handlebar. In any case, similar to the handlebar 12, the handlebar 312 has an outer circumferential surface 312a and the arrangement area 324 that is disposed inside the outer circumferential surface 312a. The arrangement area 324 is configured to arrange the electric switch unit 314 at least partially inside the outer circumferential surface 312a of the handlebar 312. Here, in the fourth embodiment, the arrangement area 324 is defined by an internal surface 312b of the handlebar 312. The handlebar 312 also has a handlebar opening or locating opening 328 in which the electric switch unit 314 is at least partially located.

The electric switch unit 314 is identical to the electric switch unit 14. Thus, the above descriptions and the illustrations of the electric switch unit 14 applies to the electric switch unit 314. The electric switch unit 314 is positioned in the the arrangement area 324 by the support 320 such that the electric switch unit 314 partially projects out from the handlebar 312 through the handlebar opening 328.

Here, the handlebar assembly 310 further comprises a cover 335 that is arranged to at least partially overlying the electric switch unit 314. The cover 335 is arranged such that the electric switch unit 314 is clamped between the cover 335 and the support 320. The cover 335 includes a cover opening 335a to at least partly expose the electric switch 314. In this way, the user can easily operate the electric switch unit 314. The cover 355 can be retained in the handlebar opening 328 by a snap-fit, friction-fit or an interference fit. Further, the cover 335 can be adhesively attached to the outer circumferential surface 312a of the handlebar 312 by an adhesive.

The cover 335 also includes an elastic part 337 to receive the operating force. The elastic part 337 is similar to the elastic part 133, but instead of being mounted to the handlebar 314, the elastic part 337 is mounted to the cover 335. The elastic part 337 can be a clear dome shaped cover that is resilient such that it returns to its original shape after being deformed by a user operating the electric switch unit 314. Preferably, the elastic part 337 is coupled to the cover 335 to provide a waterproof seal around the electric switch unit 314.

Here, the support 320 is adhesively attached to the electric switch unit 314 by an adhesive 321a. The adhesive 321a can be provided on a double-sided adhesive tape as shown, or can be a glue applied to one or both of the surfaces of the support 320 and the electric switch unit 314. The support 320 is adhesively attached to the handlebar 312 by an adhesive 321b. The adhesive 321b can be provided on a double-sided adhesive tape as shown, or can be a glue applied to one or both of the surfaces of the support 320 and the internal surface 312b of the handlebar 312.

Referring now to FIG. 13, a handlebar assembly 400 is illustrated in accordance with a fifth embodiment. Here, the handlebar assembly 400 includes a handlebar 412, an electric switch unit 414 and a support 420. The handlebar 412 can be any type of handlebar. In any case, similar to the handlebar 12, the handlebar 412 has an outer circumferential surface 412a and the arrangement area 424 that is disposed inside the outer circumferential surface 412a. The arrangement area 424 is configured to arrange the electric switch unit 414 at least partially inside the outer circumferential surface 412a. Here, in the fifth embodiment, the arrangement area 424 is defined by an internal surface 412b of the handlebar 412. The handlebar 412 also has a handlebar opening or locating opening 428 in which the electric switch unit 414 is at least partially located.

The electric switch unit 414 is identical to the electric switch unit 14. Thus, the above descriptions and the illustrations of the electric switch unit 14 applies to the electric switch unit 414. The electric switch unit 414 is positioned in the the arrangement area 424 by the support 420 such that the electric switch unit 414 partially projects out from the handlebar 412 through the handlebar opening 428.

Here, the handlebar assembly 410 further comprises a cover 435 that is arranged to at least partially overlying the electric switch unit 414. The cover 435 is arranged such that the electric switch unit 414 is clamped between the cover 435 and the support 420. The cover 435 includes a cover opening 435a to at least partly expose the electric switch 414. In this way, the user can easily operate the electric switch unit 414. Here, the cover 435 is removably coupled to at least one of the handlebar 412 and the support 420. In particular, in this embodiment, the cover 435 is removably coupled to the handlebar 412 by a pair of bolts 437a and 437b. With this arrangement, the support 420 is clamped between the electric switch unit 414 and the handlebar 412.

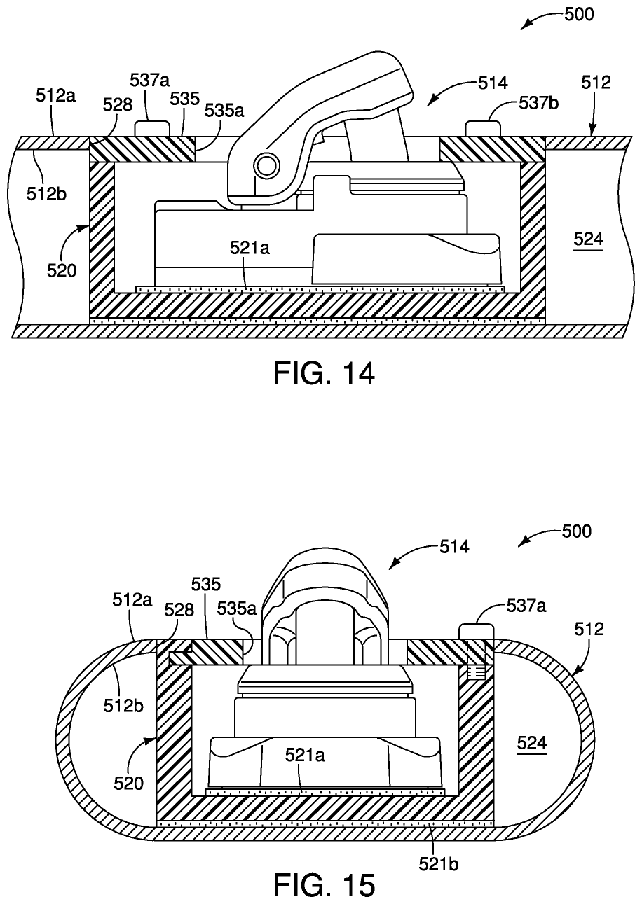

Referring now to FIGS. 14 and 15, a handlebar assembly 500 is illustrated in accordance with a sixth embodiment. Here, the handlebar assembly 500 includes a handlebar 512, an electric switch unit 514 and a support 520. The handlebar 512 can be any type of handlebar. In any case, similar to the handlebar 12, the handlebar 512 has an outer circumferential surface 512a and the arrangement area 524 that is disposed inside the outer circumferential surface 512a. The arrangement area 524 is configured to arrange the electric switch unit 514 at least partially inside the outer circumferential surface 512a of the handlebar 512. Here, in the sixth embodiment, the arrangement area 524 is defined by an internal surface 512b of the handlebar 512. The handlebar 512 also has a handlebar opening or locating opening 528 in which the electric switch unit 514 is at least partially located.

The electric switch unit 514 is identical to the electric switch unit 14. Thus, the above descriptions and the illustrations of the electric switch unit 14 applies to the electric switch unit 514. The electric switch unit 514 is positioned in the the arrangement area 424 by the support 520 such that the electric switch unit 514 partially projects out from the handlebar 512 through the handlebar opening 528.

Here, the handlebar assembly 510 further comprises a cover 535 that is arranged to at least partially overlying the electric switch unit 514. The cover 535 is arranged such that the electric switch unit 514 is clamped between the cover 535 and the support 520. The cover 535 includes a cover opening 535a to at least partly expose the electric switch 514. In this way, the user can easily operate the electric switch unit 514. The cover 535 is removably coupled to at least one of the handlebar 512 and the support 520. In particular, in the sixth embodiment, the cover 535 is removably coupled to the support 520 by a pair of screws 537a and 537b. The cover 535 is configured to be flush with the outer circumferential surface 512a of the handlebar 512 at least around an outer edge portion of the cover 535.

Here, the support 520 is a rectangular box with an open upper end that is closed off by the cover 535. The support 520 is adhesively attached to the electric switch unit 514 by an adhesive 521a. The adhesive 521a can be provided on a double-sided adhesive tape as shown, or can be a glue applied to one or both of the surfaces of the support 520 and the electric switch unit 514. The support 520 is adhesively attached to the handlebar 512 by an adhesive 521b. The adhesive 521b can be provided on a double-sided adhesive tape as shown, or can be a glue applied to one or both of the surfaces of the support 520 and the internal surface 512b of the handlebar 512.

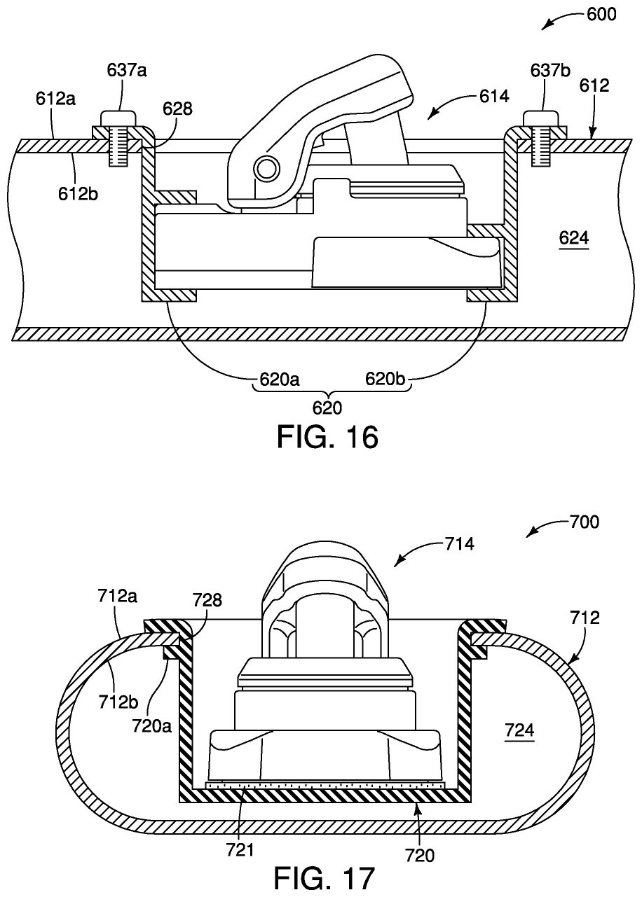

Referring now to FIG. 16, a handlebar assembly 600 is illustrated in accordance with a seventh embodiment. Here, the handlebar assembly 600 includes a handlebar 612, an electric switch unit 614 and a support 620. The handlebar 612 can be any type of handlebar. In any case, similar to the handlebar 12, the handlebar 612 has an outer circumferential surface 612a and the arrangement area 624 that is disposed inside the outer circumferential surface 612a. The arrangement area 624 is configured to arrange the electric switch unit 614 at least partially inside the outer circumferential surface 612a of the handlebar 612. Here, in the seventh embodiment, the arrangement area 624 is defined by an internal surface 612b of the handlebar 612. The handlebar 612 also has a handlebar opening or locating opening 628 in which the electric switch unit 614 is at least partially located.

The electric switch unit 614 is identical to the electric switch unit 14. Thus, the above descriptions and the illustrations of the electric switch unit 14 applies to the electric switch unit 614. The electric switch unit 614 is positioned in the the arrangement area 624 by the support 620 such that the electric switch unit 614 partially projects out from the handlebar 612 through the handlebar opening 628. Here, the support 620 is provided in the handlebar opening 628. The support 620 includes a pair of rails 620a and 620b that are removable attached to the handlebar 612 by a plurality of screws 637a and 637b. Alternatively, the handlebar 612 can be provided with integral rails.

Referring now to FIG. 17, a handlebar assembly 700 is illustrated in accordance with an eighth embodiment. Here, the handlebar assembly 700 includes a handlebar 712, an electric switch unit 714 and a support 720. The handlebar 712 can be any type of handlebar. In any case, similar to the handlebar 12, the handlebar 712 has an outer circumferential surface 712a and the arrangement area 724 that is disposed inside the outer circumferential surface 712a. The arrangement area 724 is configured to arrange the electric switch unit 714 at least partially inside the outer circumferential surface 712a of the handlebar 712. Here, in the eighth embodiment, the arrangement area 724 is defined by an internal surface 712b of the handlebar 712. The handlebar 712 also has a handlebar opening or locating opening 728 in which the electric switch unit 714 is at least partially located.

The electric switch unit 714 is identical to the electric switch unit 14. Thus, the above descriptions and the illustrations of the electric switch unit 14 applies to the electric switch unit 714. The electric switch unit 714 is positioned in the the arrangement area 724 by the support 720 such that the electric switch unit 714 partially projects out from the handlebar 712 through the handlebar opening 728.

Here, the support 720 is a cup shaped member that is removably attached to the handlebar opening 728 of the handlebar 712. In particular, in this embodiment, the support 720 includes a handlebar attachment 720a that is disposed in the arrangement area 724. The handlebar attachment 720a is made of an elastomeric material. Here, the electric switch unit 714 is adhesively attached to the support 720 by an adhesive 721. The adhesive 721 be can be provided on a double-sided adhesive tape as shown, or can be a glue applied to one or both of the surfaces of the support 720 and the electric switch unit 714.

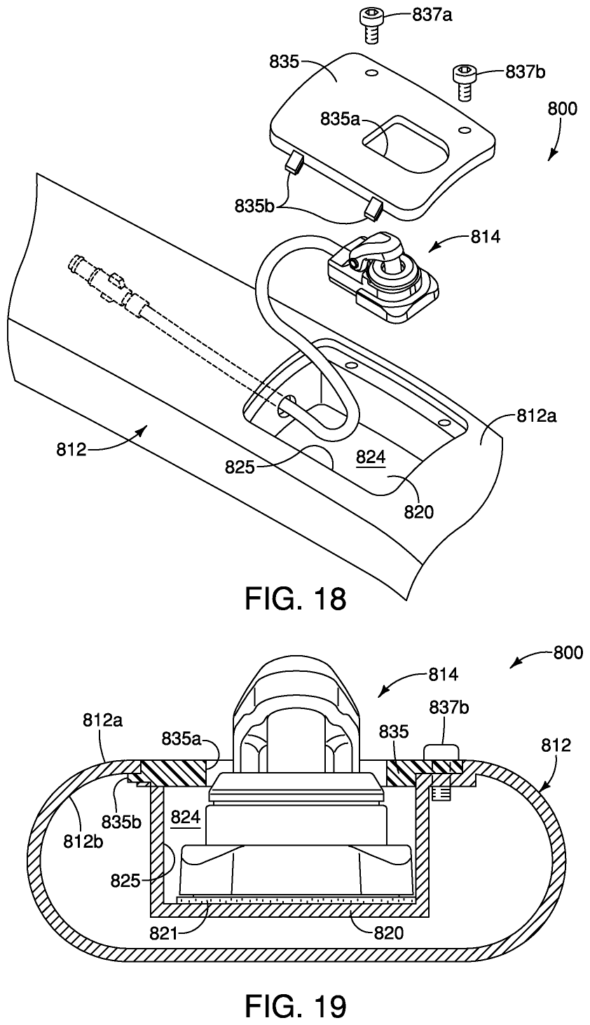

Referring now to FIGS. 18 and 19, a handlebar assembly 800 is illustrated in accordance with a ninth embodiment. Here, the handlebar assembly 800 includes a handlebar 812, an electric switch unit 814 and a support 820. The handlebar 812 can be any type of handlebar. In any case, similar to the handlebar 12, the handlebar 812 has an outer circumferential surface 812a and the arrangement area 824 that is disposed inside the outer circumferential surface 812a. The arrangement area 824 is configured to arrange the electric switch unit 814 at least partially inside the outer circumferential surface 812a of the handlebar 812. Here, in the ninth embodiment, the arrangement area 824 includes a recess 825, and the electric switch unit 14 is at least partially disposed in the recess 825. In other words, the arrangement area 824 is defined by a recess 825 formed in the outer circumferential surface 812a of the handlebar 812. The handlebar 812 also has a handlebar opening or locating opening 828 in which the electric switch unit 814 is at least partially located.

The electric switch unit 814 is identical to the electric switch unit 14. Thus, the above descriptions and the illustrations of the electric switch unit 14 applies to the electric switch unit 814. The electric switch unit 814 is positioned in the the arrangement area 824 by the support 820 such that the electric switch unit 814 partially projects out from the recess 825 in the handlebar 812.

Here, the handlebar assembly 810 further comprises a cover 835 that is arranged to at least partially overlying the electric switch unit 814. The cover 835 is arranged such that the electric switch unit 814 is clamped between the cover 835 and the support 820. The cover 835 includes a cover opening 835a to at least partly expose the electric switch 814. In this way, the user can easily operate the electric switch unit 814. The cover 835 is removably coupled to at least one of the handlebar 812 and the support 820. In particular, in the ninth embodiment, the cover 835 is removably coupled to the handlebar 812 by a pair of screws 837a and 837b. The cover 835 is configured to be flush with the outer circumferential surface 812a of the handlebar 812 at least around an outer edge portion of the cover 835.

Here, the support 820 is integrally as the bottom wall of the recess 825. In this way, the support 820 is at least partially disposed in the arrangement area 824. Also, in the ninth embodiment, the electric switch unit 814 is adhesively attached to the support 820 by an adhesive 821. The adhesive 821 be can be provided on a double-sided adhesive tape as shown, or can be a glue applied to one or both of the surfaces of the support 820 and the electric switch unit 814.

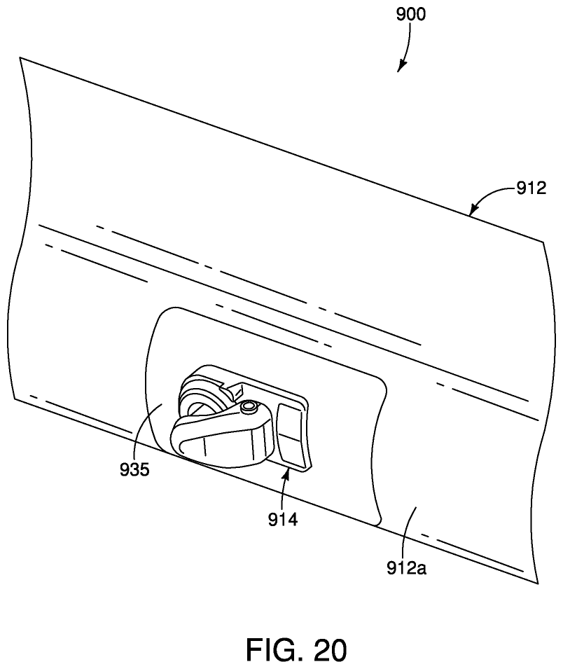

Referring now to FIG. 20, a handlebar assembly 900 is illustrated in accordance with a tenth embodiment. Here, the handlebar assembly 900 includes a handlebar 912 having an electric switch unit 914 that is provided on a rearward facing surface of a center section of the handlebar 912. The handlebar 912 can be any type of handlebar. Here, for example, the electric switch unit 914 is provided in a recess in the rearward facing surface of the center section of the handlebar 912. The recess in the handlebar 912 can be similar to the one shown in the ninth embodiment. In any case, similar to the prior embodiments, the handlebar 912 has an outer circumferential surface 912a and an arrangement area that is disposed inside the outer circumferential surface 912a. The arrangement area of the handlebar 912 is configured to with a support to arrange the electric switch unit 914 at least partially inside the outer circumferential surface 912a of the handlebar 912 similar to the prior embodiments. Here, a cover 935 is adhesively attached to the handlebar 912. Preferably, the outer surface of the cover 935 is flush with the outer circumferential surface 912a of the handlebar 912.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a human-powered vehicle field (e.g., bicycle) in an upright, riding position and equipped with the handlebar assembly. Accordingly, these directional terms, as utilized to describe the handlebar assembly should be interpreted relative to a human-powered vehicle field (e.g., bicycle) in an upright riding position on a horizontal surface and that is equipped with the handlebar assembly. The terms “left” and “right” are used to indicate the “right” when referencing from the right side as viewed from the rear of the human-powered vehicle field (e.g., bicycle), and the “left” when referencing from the left side as viewed from the rear of the human-powered vehicle field (e.g., bicycle).

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A handlebar assembly comprising:
a handlebar having an outer circumferential surface and an arrangement area disposed inside the outer circumferential surface, the arrangement area being configured to arrange an electric switch unit at least partially inside the outer circumferential surface; and
a support at least partially disposed in the arrangement area and supporting the electric switch unit to receive an operating force applied to operate the electric switch unit.

2. The handlebar assembly according to claim 1, further comprising
a cover arranged to at least partially overlying the electric switch unit.

3. The handlebar assembly according to claim 2, wherein
the cover is arranged such that the electric switch unit is clamped between the cover and the support.

4. The handlebar assembly according to claim 3, wherein
the cover includes an elastic part to receive the operating force.

5. The handlebar assembly according to claim 2, wherein
the cover is removably coupled to at least one of the handlebar and the support.

6. The handlebar assembly according to claim 2, wherein
the cover includes a cover opening to at least partly expose the electric switch.

7. The handlebar assembly according to claim 2, wherein
the cover includes an elastic part to receive the operating force.

8. The handlebar assembly according to claim 1, wherein
the cover is configured to be flush with the outer circumferential surface of the handlebar at least around an outer edge portion of the cover.

9. The handlebar assembly according to claim 1, wherein
the support is adhesively attached to the handlebar.

10. The handlebar assembly according to claim 1, wherein
the support is removably coupled to the handlebar.

11. The handlebar assembly according to claim 1, wherein
the arrangement area includes an interior space in which the electric switch unit is arranged.

12. The handlebar assembly according to claim 11, wherein
the handlebar has a handlebar opening to access the interior space, and
the support is snap-fitted into the handlebar opening.

13. The handlebar assembly according to claim 1, wherein
the support includes a handlebar attachment disposed in the arrangement area, the handlebar attachment is made of an elastomeric material.

14. The handlebar assembly according to claim 1, wherein
the arrangement area includes a recess, and the electric switch unit is at least partially disposed in the recess.

15. The handlebar assembly according to claim 1, wherein
the support is threadedly attached to the handlebar.

16. The handlebar assembly according to claim 1, wherein
the support is bolted to the handlebar.

17. The handlebar assembly according to claim 1, wherein
the support is clamped between the electric switch unit and the handlebar.

18. The handlebar assembly according to claim 1, further comprising
the electric switch unit.

19. The handlebar assembly according to claim 18, wherein
the electric switch unit includes a housing and an operating portion pivotally coupled to the housing.

20. The handlebar assembly according to claim 19, wherein
the operating portion at least partially extends beyond the outer circumferential surface in a radial direction of the handlebar.
